(19) United States
(12) Patent Application Publication
(10) Pub. No.: US 2025/0196487 A1
(43) Pub. Date: Jun. 19, 2025

(54) METHOD OF MANUFACTURING A SECURE DOCUMENT WITH A MIRROR EFFECT

(71) Applicant: IDEMIA FRANCE, Courbevoie (FR)

(72) Inventor: Denis GUERARD, Courbevoie (FR)

(73) Assignee: IDEMIA FRANCE, Courbevoie (FR)

(21) Appl. No.: 18/978,074

(22) Filed: Dec. 12, 2024

(30) Foreign Application Priority Data
Dec. 15, 2023 (FR) FR2314285

(51) Int. Cl. B32B 37/06; B32B 27/08; B32B 37/12

(52) U.S. Cl. CPC B32B 37/06; B32B 27/08; B32B 37/12; B32B 2255/10; B32B 2255/205; B32B 2307/4023; B32B 2307/412; B32B 2307/538; B32B 2554/00

(57) ABSTRACT

The invention concerns a manufacturing process for a secure document with a smooth mirror effect, in contrast to secure documents obtained using known manufacturing processes. The aim of such a manufacturing process is to improve the aesthetics and distinctive character of such a secure document.

### TECHNICAL AREA

The present application belongs to the general field of secure documents. More particularly, it concerns a manufacturing process for a secure document with a mirror effect, and a secure document obtained by means of such a manufacturing process.

The invention has a particularly advantageous application in the field of secure documents in the form of cards made of polymer materials, such as payment cards or identity cards.

The invention may also be of interest in the field of business cards, loyalty cards or gift cards, where the aesthetic appearance of these objects is particularly differentiating.

### PREVIOUS TECHNIQUE

Typically, a secure document, such as a bank card, is made up of a plurality of layers stacked one on top of the other. These layers, which may for example be made of different polymer materials such as PVC (or polyvinyl chloride), PET (or polyethylene terephthalate) or PC (or polycarbonate), make it possible, in particular, to personalize and authenticate the secure document.

In order to modify the appearance of these secure documents to offer a distinctive aesthetic, it is known to use a metallic layer designed to create a mirror effect.

FIG. 1 shows a front view of such a secure document 10. On a first surface F1, the secure document 10 has at least one zone with a ZPEM mirror effect.

For example, the mirrored zone ZPEM may cover the entire first surface F1 of the secure document 10. Alternatively, the mirrored zone ZPEM may simply cover a limited area of the first surface F1 of the secure document 10, as shown in FIG. 1.

As the secure document 10 has a substantially rectangular shape, a cutting plane I-I chosen parallel to a width of the secure document 10 is also shown in FIG. 1.

Generally speaking, the secure document 10 comprises a plurality of layers visible on FIG. 2, which represents the secure document 10 according to the cross-sectional plane I-I introduced with reference to FIG. 1.

More specifically, the secure document 10 comprises a substrate 11. In some situations, this substrate 11 may comprise a near field communication antenna such as an NFC antenna. This is particularly the case when the secure document 10 is a payment card or a travel ticket.

A first printable layer 12 is arranged on a first surface F1₁₁ of substrate 11.

A metal layer 13 covers at least part of a surface F₁₂ of the printable layer 12. Such a metal layer 13 is, for example, deposited by spraying metal particles onto part of the surface F₁₂ of the printable layer 12. Alternatively, in another example, the metal layer 13 may be a thin metal foil deposited on the surface F₁₂ of the printable layer 12.

Distinctive motifs, such as visuals, logos, trade names, brands, slogans, etc. can be printed on surface F₁₂ of the printable layer 12 as well as on a surface F₁₃ of the metal layer 13.

In order to protect the secure document 10 against any attempt at fraud and/or data theft, or more simply to protect the secure document 10 against external aggression which could alter its appearance, the surface F₁₂ of the printable layer 12 and the surface F₁₃ of the metal layer 13 are covered by a layer 14 of transparent polymer material.

A second printable layer 12′ is arranged on a second surface F2₁₁ of the substrate 11. Such a printable layer 12′ can also carry information relating to the holder of the secure document 10.

To protect the secure document 10, the surface F₁₂ of the printable layer 12′ is also covered by a layer 14′ of transparent polymer material.

The layers 11, 12, 13, 14, 12′ and 14′ are then hot-laminated, sealing the secure document 10 and its contents.

As the polymeric material making up the layers 14 and 14′ is made up of monomer chains, the homogeneity of the polymeric material may change following exposure to heat.

Indeed, during the hot lamination step leading to the secured document 10, the monomer chains making up the polymer material start to move under the effect of heat, leading to material displacements within layers 14 and 14′. When this heat exceeds the glass transition temperature of the polymer material, the monomer chains move to such an extent that, in certain areas of the layers 14 and 14′ with larger or smaller surfaces, variations in the thickness of these layers 14 and 14′ are created.

As the polymer material cools at the end of the lamination stage, the metal layer 13 takes on the shape of the surface of the layer 14 with which it is in contact, generating the mirror effect. However, as layer 14 varies in thickness, the surface in contact with metal layer 13 is imperfect, leading to the appearance of an “orange peel” effect. In other words, instead of obtaining a mirror with a smooth appearance, an unattractive visual result is obtained, as shown in FIG. 3, in which the surface of the metal layer visible through layer 14 has undulations.

There is therefore a need to propose a method of manufacturing secure documents with a mirror effect that reduces the “orange peel” effect.

### EXPLANATION OF THE INVENTION

The aim of the present invention is to remedy some or all of the disadvantages of the prior art, in particular those set out above, by offering a solution that makes it possible to obtain a mirror with a smooth appearance.

To this end, and according to a first aspect, the invention relates to a method of manufacturing a secure document presenting a mirror effect, said secure document comprising at least:
a first layer, a first surface of which is arranged on a substrate and a second surface of which is at least partially covered by a metal layer;
a second transparent polymer layer at least partially covering the second surface of the first layer and the metal layer;
said manufacturing process comprising at least one hot lamination step during which the substrate, the first layer and the second layer are joined together to form the secure document, the first layer and the second layer being bonded together by means of an adhesive material.

Such a manufacturing process is particular in that:
the lamination temperature is less than or equal to the glass transition temperature of the transparent polymer constituting the second layer;
the average surface roughness of the adhesive material is less than 0.05 micrometers (μm); and
the average surface roughness of the surface of the second layer in contact with the metal layer is also less than 0.05 μm.

By not exceeding the glass transition temperature of the transparent polymer during the hot rolling step, material displacement within the transparent polymer layer is limited. In contrast to the state of the art, the material distribution remains homogeneous throughout the polymer layer. As a result, there are no variations in thickness.

By using a sheet of transparent polymer material with a very low average surface roughness, we ensure that the surface of the polymer material layer in contact with the metal layer is as flat and smooth as possible.

In order to preserve the smooth, flat appearance of this contact surface, the inventors of the present method propose to use an adhesive material which also has a very low average surface roughness. In this way, when the adhesive material melts under the effect of heat, it spreads evenly over the surface of the metal layer, creating no variations in thickness.

As a result, when the polymer material cools at the end of the lamination stage, the metal layer that takes the form of the surface of the polymer material layer has a smooth surface with few or no imperfections.

In particular modes of implementation, the transparent polymeric material constituting the second layer belongs to the group comprising:
polycarbonate,
polyamide,
polyvinyl chloride,
polyethylene terephthalate.

In particular modes of implementation, the substrate comprises near-field communication means.

This is particularly the case when the secure document is a payment card or a transport card.

In particular embodiments, the adhesive material is an ink.

The adhesive material then fulfills a printable function of the secure document. This means that no additional material is added between the polymer layer and the metal layer, which could contribute to an “orange peel” effect when the polymer layer cools.

In particular embodiments, the ink is a transparent ink.

In particular embodiments, the adhesive material is a transparent resin.

In particular modes of implementation, the manufacturing process comprises, prior to the lamination step, a step of obtaining said second layer by lamination of the transparent polymer between two lamination plates whose surfaces in contact with the polymer material have an average surface roughness of less than 0.05 μm.

Finally, according to a second aspect, the invention concerns a secure document with a mirror effect obtained by means of the manufacturing process according to any of the implementations described above.

### BRIEF DESCRIPTION OF THE DRAWINGS

Further features and advantages of the present invention will become apparent from the description below, with reference to the accompanying drawings, which illustrate a non-limiting example. On the figures:

FIG. 1 shows a front view of a secure document with at least one mirror-effect area on a first surface;

FIG. 2 the secure document of FIG. 1 according to the sectional plane I-I introduced with reference to the latter;

FIG. 3 shows a secure document obtained by means of a manufacturing process complying with state-of-the-art techniques. The secure document thus obtained has an “orange peel” mirror effect;

FIG. 4 shows a secure document obtained using the manufacturing process described in the invention. The secure document thus obtained has a smooth mirror effect.

### DESCRIPTION OF EMBODIMENTS

The present invention proposes a manufacturing process for a secure document with a smooth mirror effect, unlike secure documents obtained using manufacturing processes known in the state of the art. This contributes to improving the aesthetics and distinctive character of such a secure document.

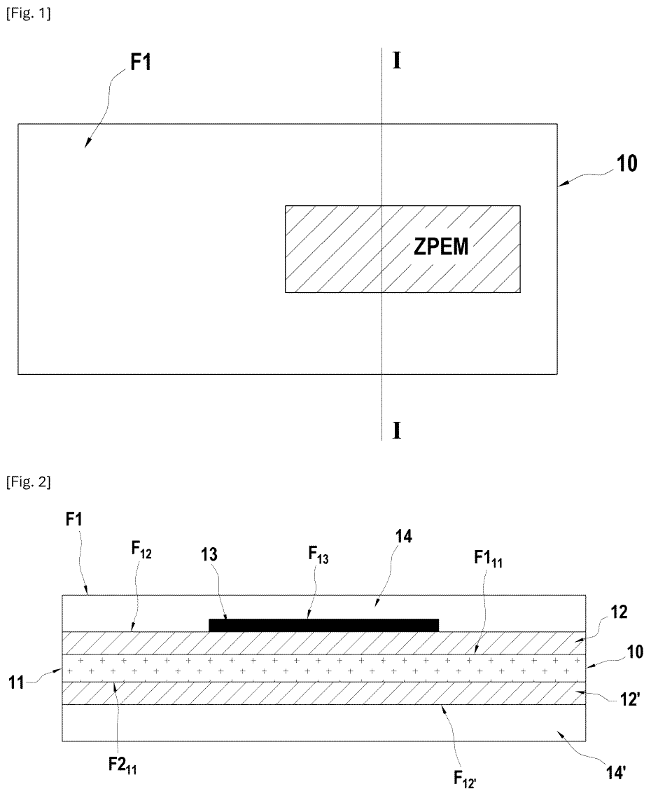

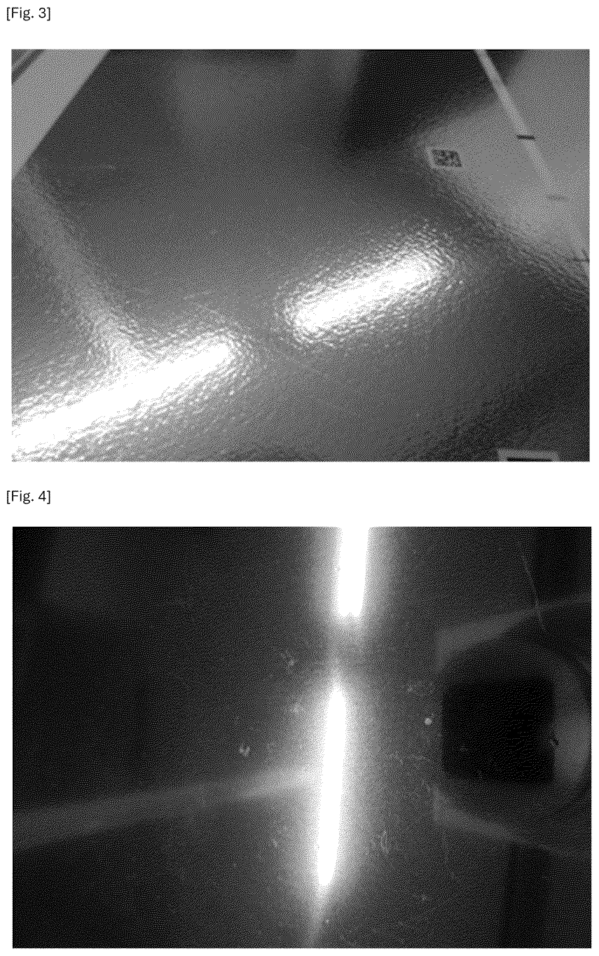

For the remainder of this description, it will be assumed that the secure document 10 is a payment card as described above with reference to FIG. 1 and FIG. 2.

In order to obtain a smooth-looking mirror effect and thus reduce the “orange peel” appearance, the inventors of the present solution propose to apply several rules when manufacturing this secure document 10, which will be described in greater detail later in this document.

As already explained with reference to FIGS. 1 and 2, the secure document 10 comprising
a substrate 11, which in other implementations may comprise a near-field communication antenna such as a;
a first printable layer 12 on the first surface F1₁₁ of substrate 11,
a metal layer 13 covering, at least in part, a surface F₁₂ of the printable layer 12;
a layer 14 of transparent polymer material covering, at least in part, the surface F₁₂ of the printable layer 12 and the surface F₁₃ of the metal layer 13;
a second printable layer 12′ on a second surface F2₁₁ of the substrate 11; and
a layer 14′ of transparent polymer material covering, at least in part, the surface F₁₂′ of the printable layer 12′.

In order to obtain the smoothest possible mirror effect, a first rule consists in depositing a layer 14 of polymer material whose surface in contact with the surface F₁₂ of the printable layer 12 and the surface F₁₃ of the metal layer 13 has an average surface roughness of less than or equal to 0.05 micrometers (μm).

Depositing a layer 14 with a very low average surface roughness ensures that the surface of layer 12 in contact with the surface F₁₂ of printable layer 12 and the surface F₁₃ of metal layer 13 is as flat and smooth as possible.

A second rule of thumb is to choose an adhesive material with an average surface roughness of 0.05 μm or less.

Selecting an adhesive material with such a property helps preserve the smooth, flat appearance of the F₁₃ surface of the metal layer 13. Thus, when the adhesive material melts under the effect of heat during the lamination step, it is evenly distributed over the surface F₁₃ of the metal layer 13 and does not create thickness variations that could cause an “orange peel” effect.

By way of example, the adhesive material may be an ink. Such an ink may, in some cases, be a transparent ink.

In other implementations, the adhesive material is a transparent resin. Such a transparent resin may be, for example, a polyvinyl chloride copolymer, or vinyl acetate. It should be noted that other types of transparent resin can be used as long as they have an average surface roughness of 0.05 μm or less.

Finally, a third rule is not to heat the laminating plates above the glass transition temperature of the polymeric material making up the layer 14.

Indeed, as already mentioned earlier in this document, as the polymer material making up the layers 14 and 14′ is made up of monomer chains, the homogeneity of this polymer material can change following exposure to heat.

By not exceeding the glass transition temperature of the transparent polymer during the hot lamination step, material displacements within the transparent polymer layer are limited, which reduces the risk of variations in the thickness of the polymer material causing an “orange peel” effect.

Using a sheet of transparent polymer material with a very low average surface roughness ensures that the surface of layer 14 in contact with the surface F₁₂ of printable layer 12 and the surface F₁₃ of metal layer 13 is as flat and smooth as possible.

Thus, when the polymer material cools at the end of the lamination step, the metal layer 13 takes on the shape of the surface of the layer 14 with which it is in contact, and consequently presents a smooth surface with few or no imperfections.

The transparent polymeric material making up layer 14 can be polycarbonate, polyamide, polyvinyl chloride or polyethylene terephthalate.

Once the polymer material constituting the layer 14, 14′ has been selected, it is necessary to adapt the temperature of the laminating plates so that it does not exceed the glass transition temperature of the chosen polymer material.

So when the polymer material chosen is polycarbonate, the temperature of the laminating plates must not exceed 150° Celsius (° C.).

When the chosen polymer material is polyamide, the temperature of the lamination plates must not exceed 145° C.

When the chosen polymer material is polyvinyl chloride, the temperature of the lamination plates must not exceed 80° C.

And finally, when the chosen polymer material is polyethylene terephthalate, the temperature of the laminating plates must not exceed 240° C.

In a particular implementation, the manufacturing process comprises, prior to the lamination step, a step of obtaining the layer 14, 14′ by lamination of the transparent polymer constituting it between two lamination plates whose surfaces in contact with the polymer material have an average surface roughness of less than 0.05 μm. This ensures that the layer 14, 14′ obtained meets the requirements of the second rule.

At the end of the lamination stage of the manufacturing process described herein, a secure document 10 is obtained with a smooth mirror effect, as shown in FIG. 4.

1. A method of manufacturing a secure document having a mirror effect, said secure document comprising at least: a first layer having a first surface arranged on a substrate and a second surface at least partially covered by a metal layer, and a second transparent polymer layer at least partially covering the second surface of the first layer and the metal layer, u said method comprising at least:
one hot lamination step of joining the substrate, the first layer and the second transparent polymer layer together to form the secure document, the first layer and the second transparent polymer layer being bonded together by means of an adhesive material,
a lamination temperature is lower than a glass transition temperature of a transparent polymer material constituting the second transparent polymer layer,
an average surface roughness of the adhesive material is less than 0.05 micrometers (μm), and
an average surface roughness of a surface of the second transparent polymer layer in contact with the metal layer is less than 0.05 μm.

2. The method of manufacturing the secure document having the mirror effect according to claim 1, wherein the transparent polymer material constituting the second transparent polymer layer is one of:
polycarbonate,
polyamide,
polyvinyl chloride, or
Polyethylene terephthalate.

3. The method of manufacturing the secure document having the mirror effect according to claim 1, wherein the substrate comprises near-field communication means.

4. The method of manufacturing the secure document having the mirror effect according to claim 1, wherein the adhesive material is an ink.

5. The method of manufacturing the secure document having the mirror effect according to claim 4, wherein the ink is a transparent ink.

6. The method of manufacturing the secure document having the mirror effect according to claim 1, wherein the adhesive material is a transparent resin.

7. The method of manufacturing the secure document having the mirror effect according to claim 1, further comprising, prior to the hot lamination step, a step of obtaining said second transparent polymer layer by lamination of the transparent polymer between two lamination plates whose surfaces in contact with the transparent polymer material have an average surface roughness of less than 0.05 μm.

8. A secure document with a mirror effect, comprising:
a first layer having a first surface arranged on a substrate and a second surface at least partially covered by a metal layer, and
a second transparent polymer layer at least partially covering the second surface of the first layer and the metal layer, wherein
the first layer and the second transparent polymer layer are bonded together by means of an adhesive material at a lamination temperature lower than a glass transition temperature of a transparent polymer material of the second transparent polymer layer,
an average surface roughness of the adhesive material is less than 0.05 micrometers (μm), and
an average surface roughness of a surface of the second transparent polymer layer in contact with the metal layer is less than 0.05 μm.

9. The method of manufacturing the secure document having the mirror effect according to claim 2, wherein the substrate comprises near-field communication means.

10. The method of manufacturing the secure document having the mirror effect according to claim 2, wherein the adhesive material is an ink.

11. The method of manufacturing the secure document having the mirror effect according to claim 10, wherein the ink is a transparent ink.

12. The method of manufacturing the secure document having the mirror effect according to claim 3, wherein the adhesive material is an ink.

13. The method of manufacturing the secure document having the mirror effect according to claim 12, wherein the ink is a transparent ink.

14. The method of manufacturing the secure document having the mirror effect according to claim 2, wherein the adhesive material is a transparent resin.

15. The method of manufacturing the secure document having the mirror effect according to claim 3, wherein the adhesive material is a transparent resin.

16. The method of manufacturing the secure document having the mirror effect according to claim 2, further comprising, prior to the hot lamination step, a step of obtaining said second transparent polymer layer by lamination of the transparent polymer between two lamination plates whose surfaces in contact with the transparent polymer material have an average surface roughness of less than 0.05 μm.

17. The method of manufacturing the secure document having the mirror effect according to claim 3, further comprising, prior to the hot lamination step, a step of obtaining said second transparent polymer layer by lamination of the transparent polymer between two lamination plates whose surfaces in contact with the transparent polymer material have an average surface roughness of less than 0.05 μm.

18. The method of manufacturing the secure document having the mirror effect according to claim 4, further comprising, prior to the hot lamination step, a step of obtaining said second transparent polymer layer by lamination of the transparent polymer between two lamination plates whose surfaces in contact with the transparent polymer material have an average surface roughness of less than 0.05 μm.

19. The method of manufacturing the secure document having the mirror effect according to claim 5, further comprising, prior to the hot lamination step, a step of obtaining said second transparent polymer layer by lamination of the transparent polymer between two lamination plates whose surfaces in contact with the transparent polymer material have an average surface roughness of less than 0.05 μm.

20. The method of manufacturing the secure document having the mirror effect according to claim 6, further comprising, prior to the hot lamination step, a step of obtaining said second transparent polymer layer by lamination of the transparent polymer between two lamination plates whose surfaces in contact with the transparent polymer material have an average surface roughness of less than 0.05 μm.
